(19) United States
(12) Patent Application Publication
(10) Pub. No.: US 2012/0261360 A1
(43) Pub. Date: Oct. 18, 2012

(54) APPARATUS FOR OPENING A CAN

(76) Inventor: Craig Souza, Bridgewater, MA (US)

(21) Appl. No.: 13/445,462

(22) Filed: Apr. 12, 2012

Related U.S. Application Data
(60) Provisional application No. 61/474,358, filed on Apr. 12, 2011.

(51) Int. Cl. B67B 7/46; B01D 43/00; B26D 3/00; B67B 7/82; B67B 7/86

(52) U.S. Cl. 210/808; 30/400; 30/410; 222/88; 83/54

(57) ABSTRACT

Apparatus for opening a can comprising a first handle and a second handle, the first and second handles being pivotally connected to one another at their distal ends; a first partial can enclosure element attached to the first handle and a second partial can enclosure element attached to the second handle, wherein when the first and second handles are brought together, the first and second partial can enclosure elements create a cavity sized to fully enclose a can; a can cutting mechanism having a first portion mounted to the first handle and a second portion mounted to the second handle, wherein the first portion of the cutting mechanism and the second portion of the cutting mechanism are configured so that when the first and second handles are brought together so as to enclose a can disposed in the cavity, the can cutting mechanism engages the can for cutting the can.

### REFERENCE TO PENDING PRIOR PATENT APPLICATION

This patent application claims benefit of pending prior U.S. Provisional Patent Application Ser. No. 61/474,358, filed Apr. 12, 2011 by Craig Souza for TUNA TERRIFIC™ (Attorney's Docket No. SOUZA-1 PROV), which patent application is hereby incorporated herein by reference.

### FIELD OF THE INVENTION

This invention relates to kitchen appliances in general, and more particularly to an appliance for opening a can.

### BACKGROUND OF THE INVENTION

Opening a can that contains liquids as well as solids, such as a can of tuna, can be a messy, cumbersome and potentially hazardous activity. Using a conventional electric or manual can opener to open a can and remove the lid of the can will often result in the spillage of some of the liquid from the can. Further, the initial puncture of the can by the cutting blade of a conventional can opener can sometimes result in the forcible ejection of some of the liquid from the can, as the contents of the can are sometimes under higher pressure relative to the ambient atmosphere. In either case, the liquid contents of the can might be spilled, splattered or splashed on the can opener, nearby objects and/or the user of the can opener. Such spillage often creates an undesirable and sometimes malodorous mess.

In some cases, the liquid in the can is a wholly undesirable product that is present merely to preserve or otherwise protect the desirable solid product contained in the can. In cases where it is desirable to separate the liquid from the solid contents of the can, conventional can openers render little or no assistance. To separate the liquid from the solid contents of a can, a user of a conventional can opener must open the can in a conventional manner, use his or her bare hands to press the lid onto the solid portion of the canned product to strain and/or squeeze the liquid out of the solid and then pour off the liquid to dispose of it. This straining procedure has at least two undesirable effects: 1) the liquid that is strained out of the can will often run onto the hands of the person straining the liquid; and 2) after the straining procedure is complete, the lid will often remain partially “buried” in the remaining solid product in the can and will be below the top rim of the wall of the can. Removing the lid from the inside of the can often involves having to “dig” the lid out of the solid part of the product, which is a potentially dangerous proposition as the edges of the lid can be extremely sharp and can easily cut the fingers of the person seeking to remove the lid. Rinsing and properly disposing of the sharp-edged lid presents a similar laceration hazard to a user's fingers.

The present invention provides a device that allows a user to open a can and dispose of unwanted liquid contained in a can in a convenient and controlled manner while also providing for a cleaner and safer way of handling and disposing of a can lid and an opened can.

### SUMMARY OF THE INVENTION

The present invention provides apparatus for opening a can in a convenient, and controlled manner.

In one form of the present invention, there is provided apparatus for opening a can, the apparatus comprising:

a first handle and a second handle, the first handle and the second handle being pivotally connected to one another at their distal ends;
a first partial can enclosure element attached to the first handle and a second partial can enclosure element attached to the second handle, wherein when the first and second handles are brought together, the first and second partial can enclosure elements create a cavity sized to fully enclose a can;

a can cutting mechanism having a first portion mounted to the first handle and a second portion mounted to the second handle, wherein the first portion of the cutting mechanism and the second portion of the cutting mechanism are configured so that when the first handle and the second handle are brought together so as to enclose a can disposed in the cavity, the can cutting mechanism engages the can for cutting the can.

In another form of the invention, there is provided a method for opening a can and controlling liquid contained therein, comprising:

providing a can opener comprising:
a first handle and a second handle, the first handle and the second handle being pivotally connected to one another at their distal ends;
a first partial can enclosure element attached to the first handle and a second partial can enclosure element attached to the second handle,
wherein when the first and second handles are brought together, the first and second partial can enclosure elements create a cavity sized to fully enclose a can;
a can cutting mechanism having a first portion mounted to the first handle and a second portion mounted to the second handle, wherein the first portion of the cutting mechanism and the second portion of the cutting mechanism are configured so that when the first handle and the second handle are brought together so as to enclose a can disposed in the cavity, the can cutting mechanism engages the can for cutting the can;

positioning a can in the second partial can enclosure element;

bringing the first handle and the second handle together so as to enclose the can disposed in the cavity; and

opening the can while it is fully enclosed within the can enclosure elements.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1 and 2 are perspective views showing a can opener, in a closed position, formed in accordance with the present invention;

FIG. 3 is a top view of the can opener of FIGS. 1 and 2, with the can opener being shown in an open position;

FIG. 4 is an exploded view of the bottom portion of the can opener;

FIG. 5 is an exploded view of the top portion of the can opener;

FIGS. 6 and 7 are views of the top portion and bottom portion, respectively, of an alternative form of the can opener of the present invention;

FIG. 8 is a view of the bottom portion of another alternative form of the can opener of the present invention;

FIG. 9 is a view of the top portion of another alternative form of the can opener of the present invention; and

FIG. 10 is a partially exploded view of the top portion of the can opener of FIG. 9.

### DESCRIPTION OF THE INVENTION

The present invention provides apparatus for opening a can in a convenient and controlled manner.

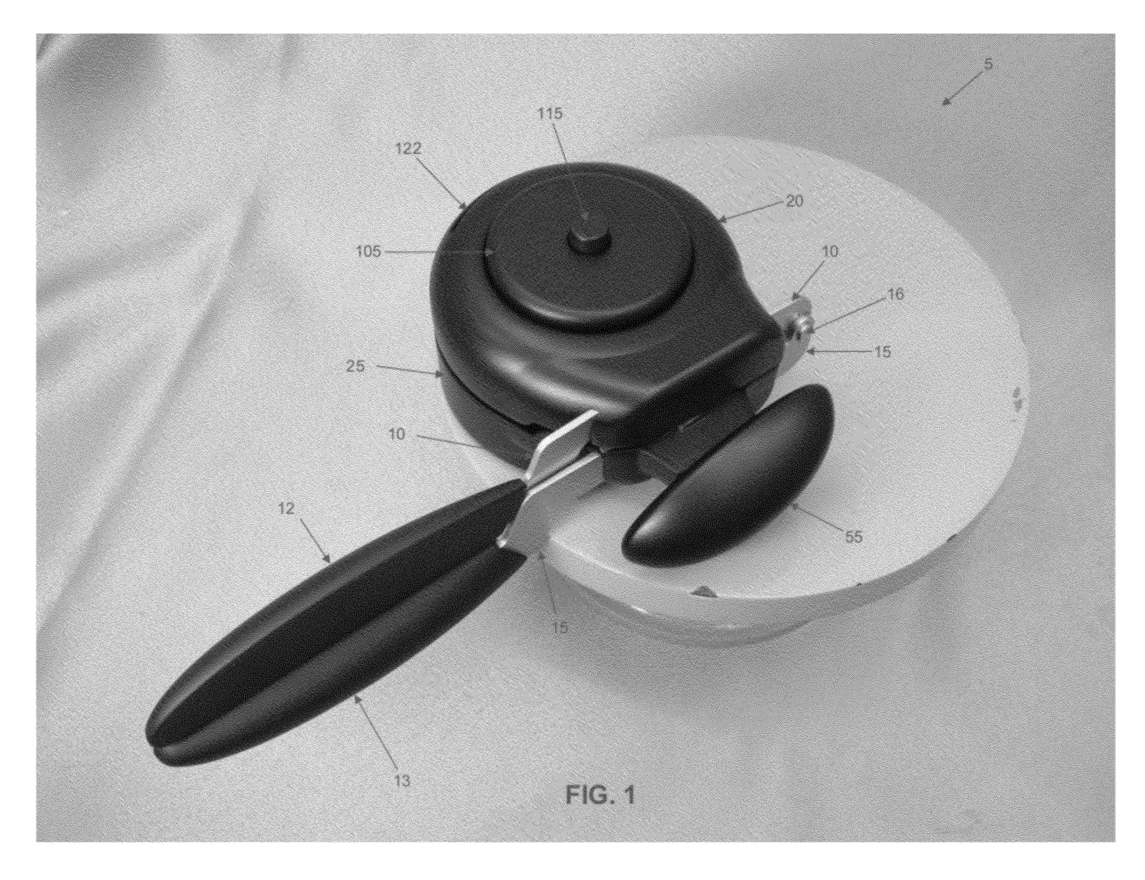

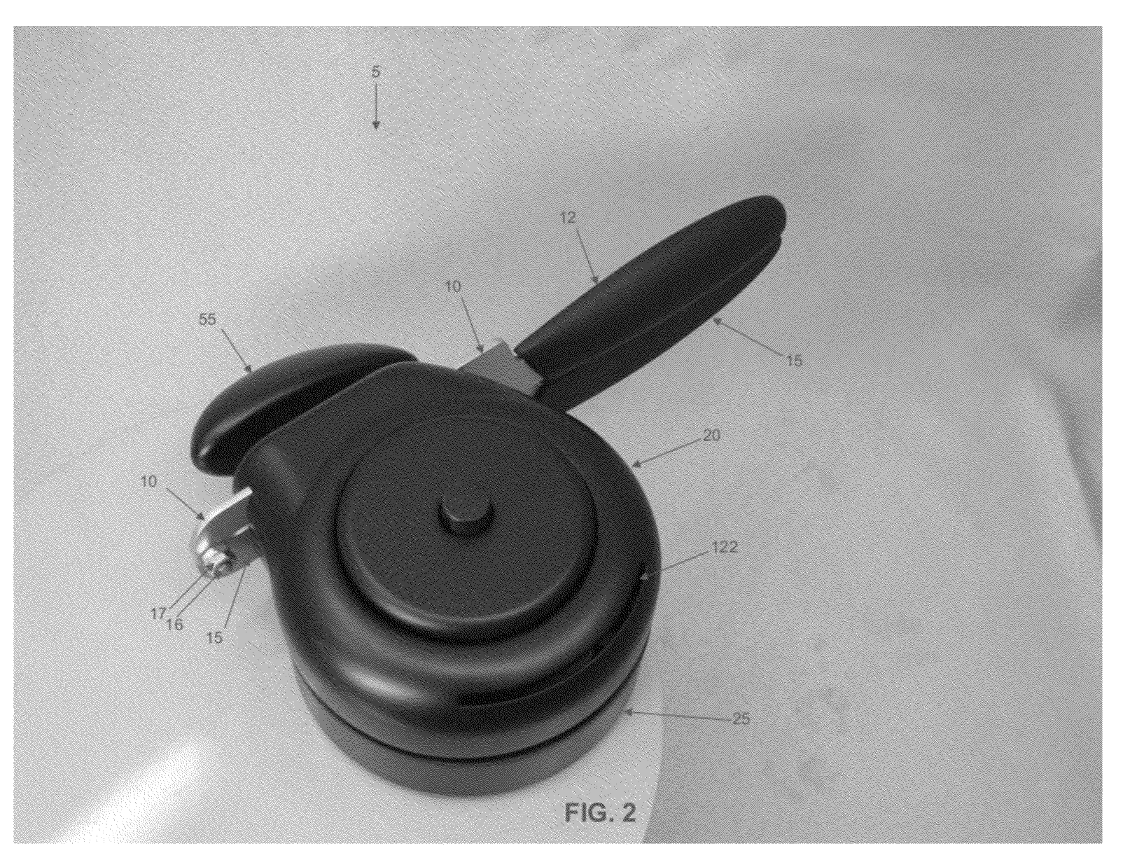

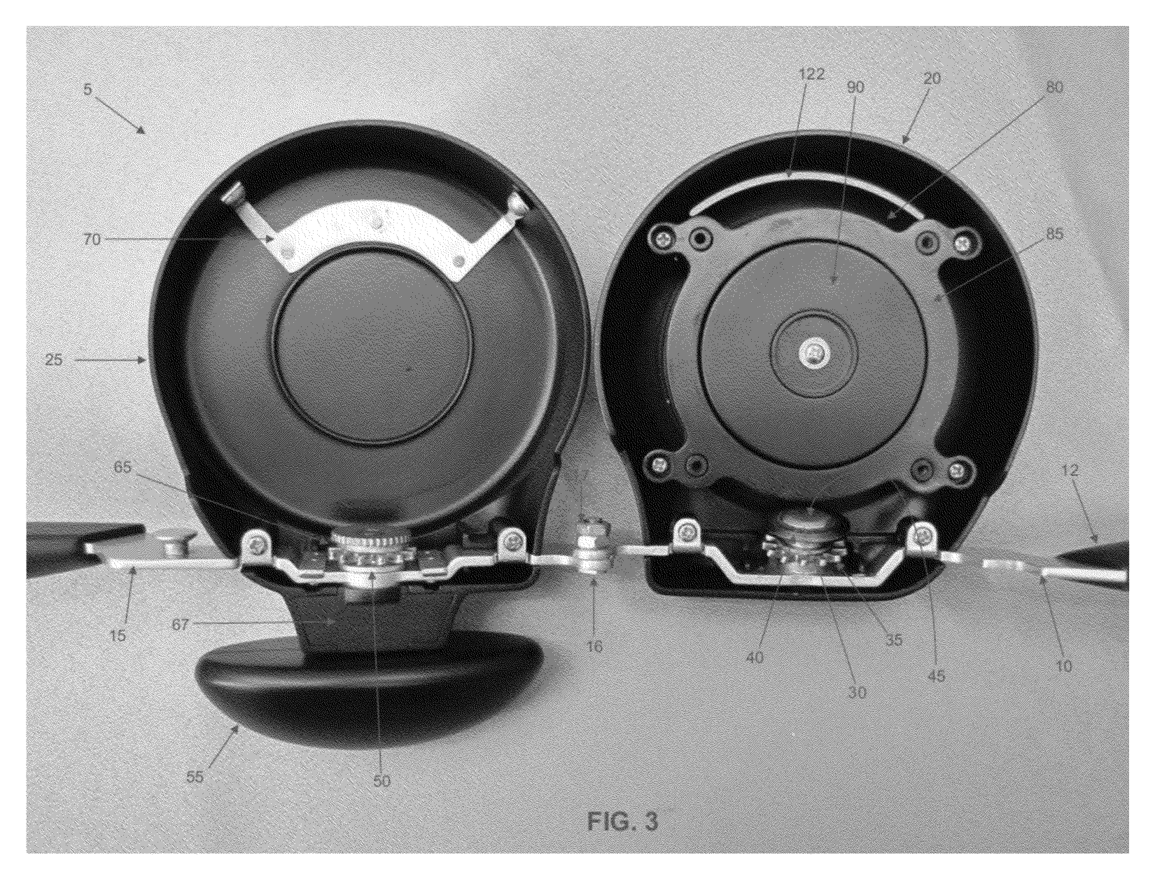

In accordance with the present invention, and looking now at FIGS. 1-5, there is provided a novel can opener 5 for opening a can, separating the liquid and solid components of the can, disposing of any unwanted liquid contained in the can and disposing of the can lid.

Can opener 5 is provided with a first (i.e., top) handle 10 and a second (i.e., bottom) handle 15. First handle 10 is pivotally attached to second handle 15 at their distal ends by a bolt 16 and nut (s) 17, or similar means known in the art. A first (i.e., top) partial can enclosure element 20 is mounted to first handle 10. A second (i.e., bottom) partial can enclosure element 25 is mounted to second handle 15. First partial can enclosure element 20 and second partial can enclosure element 25 are configured such that when first handle 10 and second handle 15 are brought together, first partial can enclosure element 20 and second partial can enclosure element 25 come together to form a cavity which fully encloses a can placed between the two partial can enclosure elements.

A first partial can cutting mechanism 30 is mounted to first handle 10. First partial can cutting mechanism 30 comprises a rotating gear 35, a can cutting blade 40 and a rotating gear pin 45. A second partial can cutting mechanism 50 is mounted to second handle 15. Second partial can cutting mechanism 50 comprises a turning key knob 55, a turning key 60, and a top turning gear 65. Second partial can cutting mechanism 50 may be partially covered by turning gear housing 67. First partial can cutting mechanism 30 and second partial can cutting mechanism 50 are configured such that when a can is inserted in second partial can enclosure element 25 and first handle 10 and second handle 15 are brought together, can cutting blade 40 will puncture the lid of a can and top turning gear 65 will engage rotating gear 35.

Can stabilizer 70 is mounted to the inside of second partial can enclosure element 25 to “cradle” the can and prevent the can from migrating within second partial can enclosure element 25.

In one preferred method of using the invention, a user begins by placing second partial can enclosure element 25 on a flat surface, such as a kitchen countertop. A user may open can opener 5 by grasping handle grip 12 of first handle 10 and lifting first handle 10. Lifting first handle 10 will raise first partial can enclosure element 20 and expose the inside of second partial can enclosure element 25. The user may then place an unopened can inside the can opener 5 by placing the bottom of the can into second partial can enclosure element 25 so that the side of the can fits snugly against can stabilizer 70.

After the can is properly positioned in the second partial can enclosure element 25, the user may close can opener 5 by moving first handle 10 toward second handle 15 until the handle grip 12 on first handle 10 is flush with handle grip 13 of second handle 15. At this point, the can is now completely contained between first partial can enclosure element 20 and second partial can enclosure element 25, and the user is protected from any splash or splatter and any liquid which may spill out of the can in an uncontrolled manner. In addition, by closing the device in this manner, cutting blade 40 will puncture the can lid and top turning gear 65 will engage rotating gear 35.

The user may then cause the can to be rotated within the can enclosure element (i.e., the cavity formed when first partial can enclosure element 20 and second partial can enclosure element 25 are brought together) by turning turning key knob 55, which will cause turning key 60, to turning gear 65 and rotating gear 35 to rotate. The rotation of the can subjects the circumference of the lid to cutting blade 40, thereby cutting the can lid and separating it from the walls of the can. If desired, after can cutting blade 40 has separated the lid from the can, can opener 5 may be opened and the lid discarded.

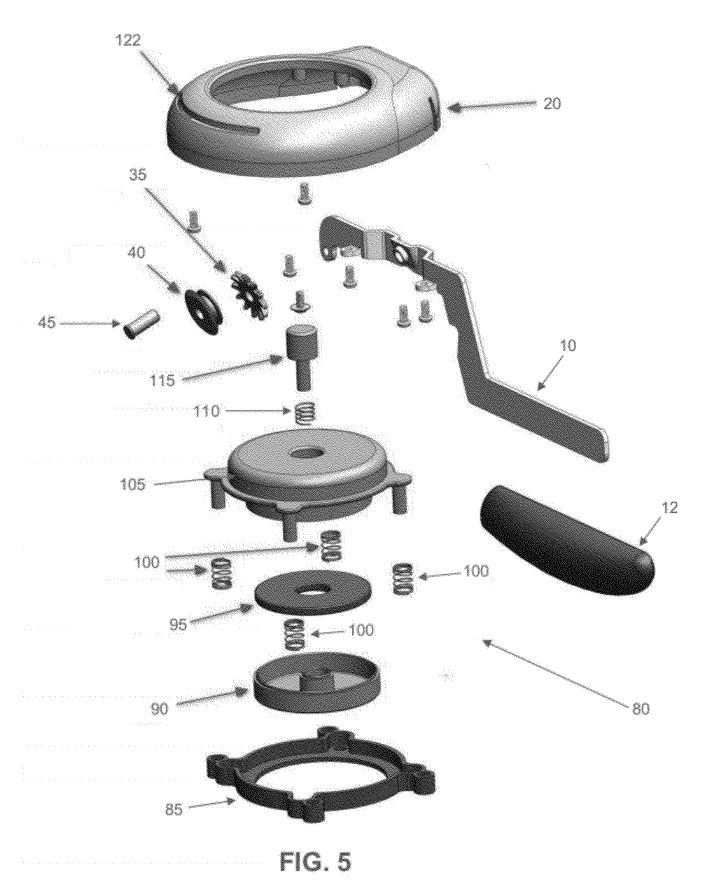

In one preferred form of the invention, and looking now at FIG. 5, first partial can enclosure element 20 further comprises a straining element 80 for separating the liquid and solid components of a can after the can has been opened. Straining element 80 comprises a press housing 85, a press bottom 90, a magnet 95, press springs 100, a press top 105, a lid eject tension spring 110 and a lid eject pin 115. First partial can enclosure element 20 is also formed with an arc-shaped slit 122 so as to allow liquid to escape from within the can enclosure element when the user positions the can opener 5 such that slit 122 is at or near the lowest point of the can enclosure element (e.g., by tipping the can opener at an angle).

Straining element 80 may be used to separate the liquid from the solid product contained in the can in the following manner. After can cutting blade 40 has separated the lid of the can from the rest of the can in the manner described above, the user may then press down on press top 105, which will cause press bottom 90 to exert force on the severed lid that is still inside the can. The force exerted on the lid of the can will press the lid against the solid product in the can, thereby separating the liquid from the solid in the can. The lid itself, which is only slightly smaller than the opening in the top of the can will prevent most of the solid product from escaping the can. The user may now position (e.g., tilt) can opener 5 so that slit 122 is located at or near the lowest point of the can enclosure element. The liquid that is squeezed out of the can will run out of the can and into the can enclosure element, and may subsequently be poured out of slit 122 into a desired disposal receptacle.

After straining out the unwanted liquid from a can, the user may prepare to remove the solid contents of the can. To open can opener 5, the user should place can opener 5 on a flat surface such that second partial can enclosure element 25 is resting on the fiat surface. The user may then lift first handle 10 and pivot it about bolt 16 and nut (s) 17 until first handle 10 is at approximately a one hundred eighty degree angle to second handle 15. The lid will still be stuck to press bottom 90 because of the force exerted by magnet 95, so the user will, have unfettered access to the solid contents of the can, which will still be in the can in second partial can enclosure element 25.

Once the solid contents of the can (e.g., tuna) have been removed from the can, the top lid of the can, and the can itself, are ready for disposal.

As previously described, the lid of the can will remain stuck to the bottom surface of press bottom 90 because of the force exerted by magnet 95. To dispose of the lid without risk of being cut by its sharp edges, the user may invert or tilt can opener 5 over a desired disposal receptacle and press lid eject pin 115. Pressing lid eject pin 115 exerts a force on the lid sufficient to overcome the force exerted by magnet 95, which causes the lid to “fall off” of press bottom 90 and into a disposal receptacle. The can may be disposed of by manually lilting the can out of second partial can enclosure element 25, and disposing of it in a disposal receptacle.

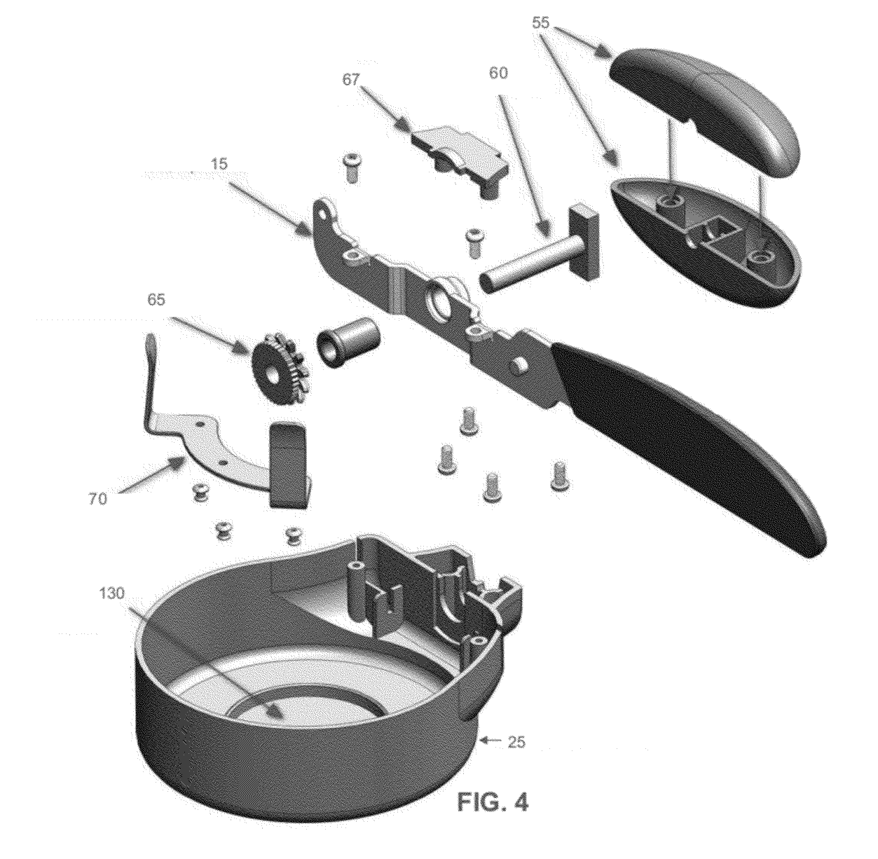

In one preferred form of the invention, and looking now at FIG. 4, second partial can enclosure element 25 may be formed with a hole 130 in its bottom portion such that a can placed in second can enclosure mechanism 25 may be manually pushed out from underneath second partial can enclosure element 25. In this form of the invention, the user may elect the can out of second partial can enclosure element 25 into the disposal receptacle by inverting or tipping can opener 5 over the disposal receptacle and by passing a finger through hole 130 so as to push a can out of second partial can enclosure element 25.

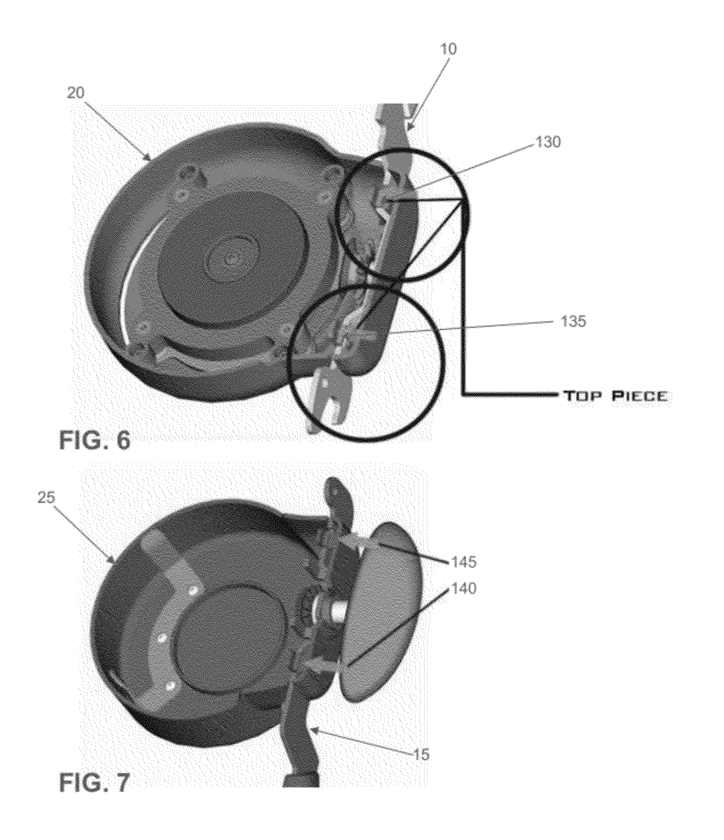

In another form of the present invention, and looking now at FIGS. 6-10, a can opener 5 having removable partial can enclosure elements is provided. In this embodiment, first partial can enclosure element 20 is detachably mounted to first handle 10 by snap tabs 130 and 135 and second partial can enclosure element 25 is detachably mounted to second handle 15 by snap tabs 140 and 145. By pushing snap tabs 130 and 135, first partial can enclosure element 20 can be detached from first handle 10. By pushing snap tabs 140 and 145, second partial can enclosure element 25 can be detached from second handle 15. By detaching both partial can enclosure elements, the user may use can opener 5 in a manner similar to that of a conventional can opener.

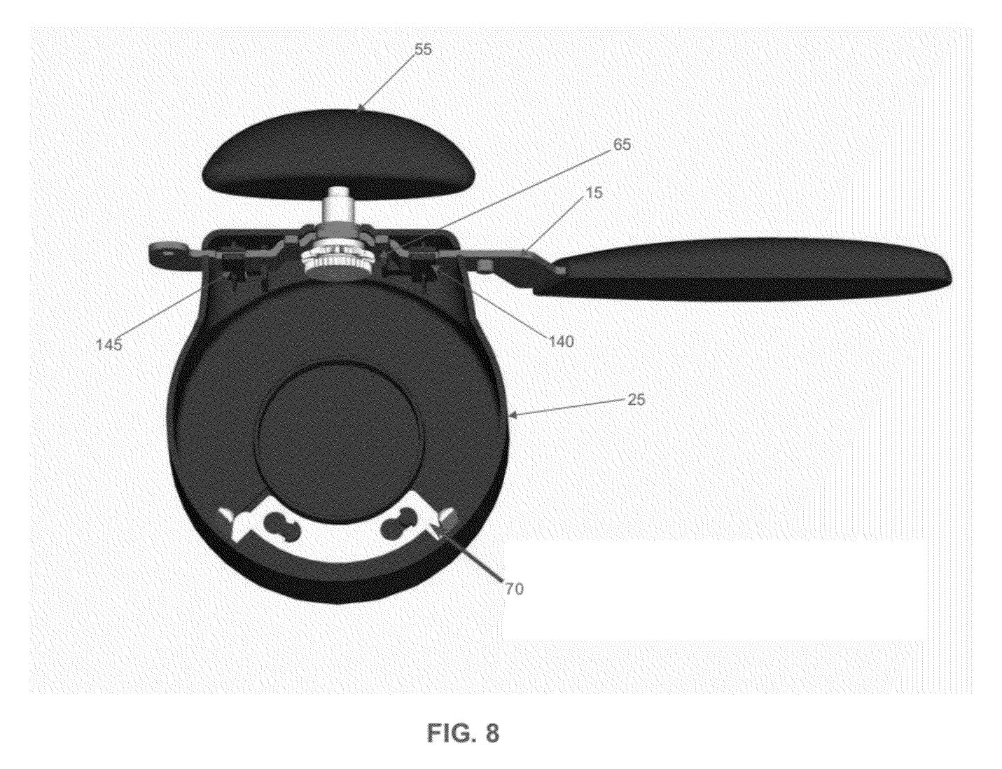

In another form of the present invention, and looking now at FIG. 8, can stabilizer 70 may be detachably mounted to second partial can enclosure element 25, so as to allow can stabilizer to be removed for cleaning or other purposes.

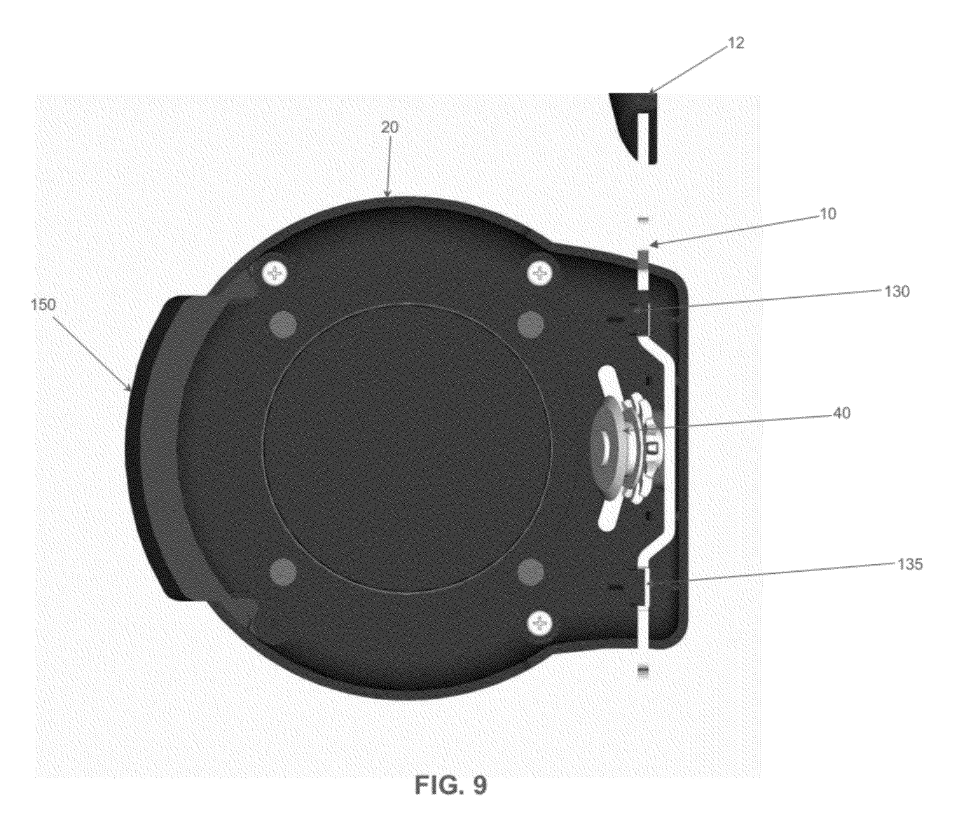

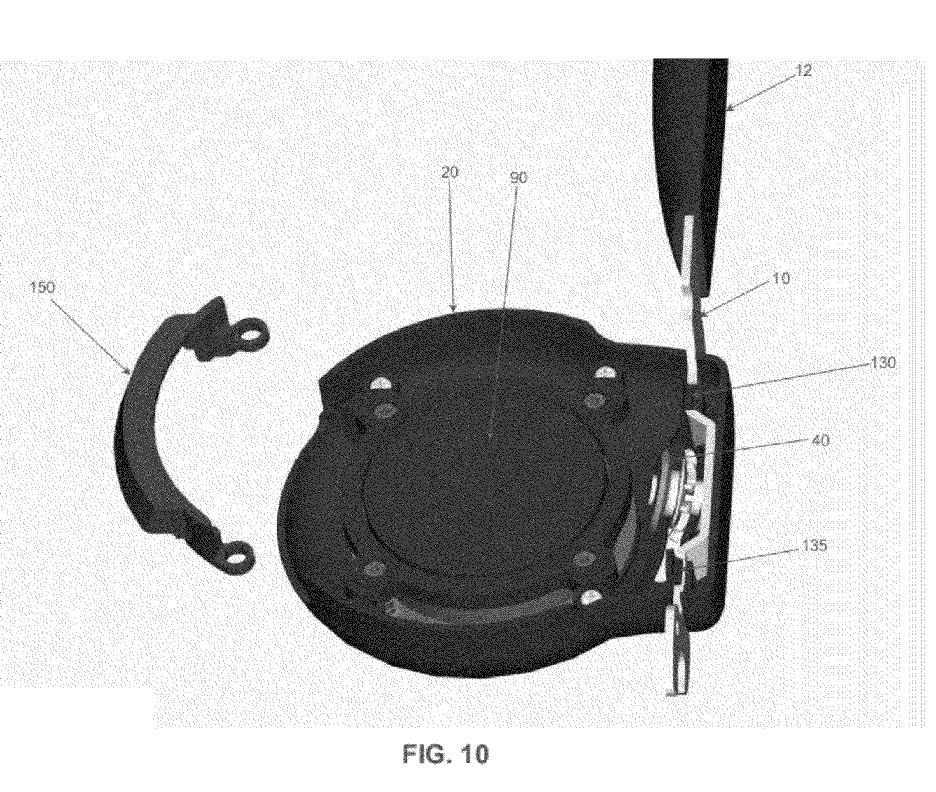

In yet another form of the present invention, and looking now at FIGS. 9 and 10, first partial can enclosure element 20 may be formed with a spout 150 to better control liquid that may be poured out of the can enclosure element. In this form of the invention, a user may position can opener 5 so that spout 150 is located at or near the lowest point of the can enclosure element (e.g., by tipping can opener 5), so as to pour any unwanted liquid out of the can enclosure element and into a disposal receptacle.

Preferably, both first handle 10 and second handle 15 are formed from a rigid material, such as metal.

### Further Modifications

It will be understood that many additional changes in the details, materials, steps and arrangements of parts, which have been herein described and illustrated in order to explain the nature of the invention, may be made by those skilled in the art while remaining within the principles and scope of the present invention.

What is claimed is:

1. Apparatus for opening a can, the apparatus comprising:
a first handle and a second handle, the first handle and the second handle being pivotally connected to one another at their distal ends;
a first partial can enclosure element attached to the first handle and a second partial can enclosure element attached to the second handle, wherein when the first and second handles are brought together, the first and second partial can enclosure elements create a cavity sized to fully enclose a can;
a can cutting mechanism having a first portion mounted to the first handle and a second portion mounted to the second handle, wherein the first portion of the cutting mechanism and the second portion of the cutting mechanism are configured so that when the first handle and the second handle are brought together so as to enclose a can disposed in the cavity, the can cutting mechanism engages the can for cutting the can.

2. The apparatus of claim 1 wherein the can is a can of tuna.

3. The apparatus of claim 1 further comprising a compression element mounted to the first partial can enclosure element and adapted to apply pressure to the contents of the can so as to separate a solid product from a liquid product.

4. The apparatus of claim 1 further comprising a magnet element disposed inside the first partial can enclosure element.

5. The apparatus of claim 1 further comprising a lid electing element.

6. The apparatus of claim 1, wherein a slit is disposed in the first partial can enclosure element so as to allow liquid to be poured out of the first and second can enclosure elements in a controlled manner.

7. The apparatus of claim 1, wherein a hole is formed in the second partial can enclosure element, wherein the hole has a diameter which is less than the diameter of a can, such that a user is able to eject a can from the second partial can enclosure element by pushing the can out from below.

8. The apparatus of claim 1, wherein the first partial can enclosure element is detachably attached to the first handle and the second partial can enclosure element is detachably attached to the second handle.

9. A method for opening a can and controlling contained therein, comprising:
providing a can opener comprising:
a first handle and a second handle, the first handle and the second handle being pivotally connected to one another at their distal ends;
a first partial can enclosure element attached to the first handle and a second partial can enclosure element attached to the second handle, wherein when the first and second handles are brought together, the first and second partial can enclosure elements create a cavity sized to fully enclose a can;
a can cutting mechanism having a first portion mounted to the first handle and a second portion mounted to the second handle, wherein the first portion of the cutting mechanism and the second portion of the cutting mechanism are configured so that when the first handle and the second handle are brought together so as to enclose a can disposed in the cavity, the can cutting mechanism engages the can for cutting the can;
positioning a can in the second partial can enclosure element;
bringing the first handle and the second handle together so as to enclose the can disposed in the cavity; and
opening the can while it is fully enclosed within the can enclosure elements.

10. A method according to claim 9, further comprising the step of applying pressure to the contents of the can so as to separate a sold product from a liquid product.
